(19) United States
(12) Patent Application Publication
(10) Pub. No.: US 2026/0195923 A1
(43) Pub. Date: Jul. 9, 2026

(54) NAVIGATION ASSISTED EXTRINSIC CALIBRATION FOR MULTI-CAMERA MONITORING SYSTEMS AND APPLICATIONS

(71) Applicant: NVDIA Corporation, Santa Clara, CA (US)

(72) Inventors: Sean Midthun PIEPER, Waldport, OR (US); Qunjie ZHOU, München (DE); Naveen Kumar RAI, Gilroy, CA (US); Laura LEAL-TAIXE, Florence (IT)

(21) Appl. No.: 19/219,850

(22) Filed: May 27, 2025

(30) Foreign Application Priority Data
Jan. 3, 2025 (IT) 102025000000024

(51) Int. Cl. G06T 7/80; G05D 1/243; G05D 1/244; G05D 1/247; G05D 101/00

(52) U.S. Cl. CPC G06T 7/80; G05D 1/243; G05D 1/244; G05D 1/247; G05D 2101/22; G06T 2207/30204

(57) ABSTRACT

In various examples, navigation aid assisted extrinsic calibration for multi-camera monitoring systems and applications is provided. Image data is obtained by capturing images of a mobile calibration platform as the platform travels through an environment. Concurrently, the mobile platform captures navigation aid data (based on images of fiducial markers and/or received wireless navigation signals) representing the mobile platform's own location in 3D space. A multiple-camera calibration technology performs an optimization based on a composite fusion of distinct sets of navigation aid data used as optimization constraints to compute an extrinsic calibration transformation for individual sensors of a plurality of optical sensors distributed about an environment.

### CROSS-REFERENCE TO RELATED APPLICATIONS

This application is a United States Patent Application claiming priority to, and the benefit of Italian Patent Application No. 102025000000024, titled “NAVIGATION ASSISTED EXTRINSIC CALIBRATION FOR MULTI-CAMERA MONITORING SYSTEMS AND APPLICATIONS” filed on 3 Jan. 2025, which is incorporated by reference in its entirety.

### BACKGROUND

Multi-camera-based monitoring systems represent a technology often used to determine the location of objects or people within an enclosed environment. These monitoring systems may be used for applications such as security and surveillance, to monitor activities in factories and warehouses, in retail analytics to monitor customer behaviors, and/or for crowd management/public safety at events, gatherings, or public spaces. A set of cameras distributed around a facility may capture image data from different vantage points, and that image data may be processed using computer vision algorithms to extract positional information. By strategically placing cameras in key locations, a comprehensive view of the environment can be achieved in a cost-effective and scalable manner, as fewer sensor devices are needed as compared to other technologies like radio frequency identification (RFID) or Bluetooth beacons, which need to be distributed with relatively high densities to provide even moderately accurate/precise data.

### SUMMARY

Embodiments of the present disclosure relate to navigation aid assisted extrinsic calibration for multi-camera monitoring systems and applications. Systems and methods are disclosed that provide for technologies for establishing an extrinsic calibration between cameras of a multi-camera-based monitoring system that may be used to track and/or determine the position of objects within a monitored environment.

In contrast to conventional systems, one or more embodiments of the present disclosure comprise a multiple-camera calibration technology that performs an optimization based on a composite fusion of distinct sets of mobile calibration platform-based navigation aid location data. That is, an optimization algorithm, such as a bundle adjustment algorithm, may be used to compute an extrinsic calibration transformation for individual sensors of a plurality of optical sensors distributed about an environment. The extrinsic camera calibration permits two-dimensional coordinate translations between cameras so that images of a given object captured by the cameras may be applied to a triangulation algorithm to establish a set of three-dimensional (3D) coordinates of that object - which may then be mapped to a three-dimensional reference coordinate system associated with the environment.

In some embodiments, image data is obtained by capturing images (e.g., streaming image data) of a mobile calibration platform as the mobile calibration platform travels through the environment. The mobile calibration platform may comprise a cart, robot, vehicle, aerial drone, and/or other platform that can be controlled to travel a path through the environment. Concurrently, the mobile platform captures navigation aid data representing the mobile platform's own location in 3D space. In some embodiments, the mobile calibration platform may comprise an image sensor that captures images of one or more fiducial markers as the platform travels the path through the monitored environment. For example, fiducial markers may be placed at various locations within the environment at known 3D coordinates and with known orientation angles (e.g., on walls, pillars, supports, or other fixed structural surfaces within the environment). In some embodiments, the mobile calibration platform may comprise a navigation signal receiver that may compute navigation data that comprises a set of location data based at least on navigation signals transmitted into one or more regions of the monitored environment. A set of navigation transmitters (e.g., beacons) may be positioned along at least a portion of the path traversed by the mobile calibration platform. As the mobile calibration platform is traveling along the path through the monitored environment, the plurality of optical sensors distributed through the environment are recording timestamped images (e.g., streaming image data) of the mobile calibration platform from various locations and angles.

In some embodiments, the image data from the plurality of optical sensors and time-correlated navigation location data (derived based at least on the fiducial markers and/or navigation signals) may be used as input to an optimization algorithm (e.g., a bundle adjustment algorithm) to perform an extrinsic camera calibration of the plurality of optical sensors that compute an extrinsic calibration transformation for each of the individual sensors of the plurality of optical sensors. A coordinate frame of a 3D reconstructed space established by the bundle adjustment algorithm may comprise a relative coordinate system that may be used to translate coordinates of observable features between fields of view of the plurality of optical sensors that have been calibrated together. The relative coordinate system may be aligned (e.g., using a rigid transformation for rotation and translation) to a global coordinate system associated with the monitored environment (e.g., a factory coordinate space) to determine 3D coordinates for an observed feature in the global coordinate system.

### BRIEF DESCRIPTION OF THE DRAWINGS

The present systems and methods for navigation aid assisted extrinsic calibration for multi-camera monitoring systems and applications are described in detail below with reference to the attached drawing figures, wherein:

FIG. 1 is an example flow diagram for a process for a multi-camera facility extrinsic calibration system, in accordance with some embodiments of the present disclosure;

FIG. 2 is a data flow diagram for an example process for producing aligned image data and aligned optimization constraint data from image data and navigation aid data, in accordance with some embodiments of the present disclosure;

FIG. 3 is a diagram illustrating an example environment traveled by a mobile calibration platform, in accordance with some embodiments of the present disclosure;

FIG. 4 is a data flow diagram illustrating an example environment monitoring system, in accordance with some embodiments of the present disclosure;

FIG. 5 is a flow chart illustrating an example method for multi-camera facility extrinsic calibration, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

Systems and methods are disclosed related to navigation aid assisted extrinsic calibration for multi-camera monitoring systems and application.

The present disclosure relates to camera extrinsic calibration technologies. More specifically, the systems and methods presented in this disclosure provide for technologies for establishing an extrinsic calibration between cameras of a multi-camera-based monitoring system that may be used to track and/or determine the position of objects within a monitored environment.

Extrinsic camera calibration is a process used to compute the relative rotation and translation parameters associated with each camera of a system to ensure that a common reference frame is established, allowing for accurate and consistent measurements across the different views captured by the different cameras. Establishing an extrinsic camera calibration of at least some accuracy is typically a prerequisite for performing computer vision and perception tasks, such as generating a 3D reconstruction, where data from multiple cameras is combined to create a single, cohesive model of the environment. Without calibration, discrepancies between the cameras'perspectives can lead to errors and inconsistencies in measurements used for tracking the position of objects. Calibration ensures that image data fusion is accurate, enabling better decision-making and analysis.

However, establishing an effective extrinsic camera calibration in systems where cameras are distributed over a large environment remains challenging. Even when a camera has a precisely known nominal coordinate position when installed, the error in rotation and translation of a camera as installed by a human may be off by an order of ten degrees, for example. Such an error may be sufficiently large to render accurate and consistent measurements across the different views for precise object tracking. Some extrinsic camera calibration techniques have been developed that are based on viewing camera image data feeds from multiple cameras and noting the observed position of known fixed landmarks in the environment. An operator may log into the camera feed and interactively mark on the screen those landmarks with known position, and that information is fed into an algorithm to calculate a homography for those cameras. However, these landmarked-based techniques are known to be limiting with respect to accurately capturing depth information.

Transmitter-receiver-based indoor positioning systems (IPSs) represent another technology that may be used in the process of establishing an effective multi-camera extrinsic camera calibration. In such systems, a set of navigation transmitters (or beacons) transmit wireless navigation signals (e.g., radio frequency (RF) and/or optical signals) that may be received and processed by a receiving unit within the environment to compute their own position based on time-of-flight (ToF) and triangulation computations. To perform an extrinsic multi-camera calibration, a mobile platform (e.g., a robot, a pushcart, an aerial drone, etc.) comprising a fiducial marker visible to the set of cameras may traverse through the environment. The mobile platform may further comprise an IPS receiver unit. As such, the mobile platform may compute an accurate indication of its location as it traverses through the environment, as images of the fiducial marker are captured by the set of cameras. The location data and image data may be correlated in time (e.g., based on timestamps) and processed (e.g., by a simultaneous localization and mapping (SLAM) algorithm) to perform a 3D reconstruction that provides a pose estimate (translation and rotation) for each individual camera of the set of cameras. However, deploying a transmitter-receiver-based indoor positioning system (IPS) for the purpose of a multi-camera extrinsic camera calibration is an expensive and time-consuming process with respect to both hardware components and the time needed to install the system. While a similar process may be performed by capturing images of the mobile platform with a fiducial marker without processing IPS location data, in practice the accuracy of measurements may be expected to range, for example from twenty centimeters to a meter, which again may be a sufficiently large margin of error to render accurate and consistent measurements across the different views for precise object tracking.

In contrast to these existing multi-camera extrinsic camera calibration technologies, one or more embodiments of the present disclosure comprise a multiple-camera calibration technology that performs an optimization based on a composite fusion of distinct sets of mobile calibration platform-based navigation aid location data. That is, an optimization algorithm, such as a bundle adjustment algorithm, may be used to compute an extrinsic calibration transformation for individual sensors of a plurality of optical sensors distributed about an environment. The extrinsic camera calibration permits two-dimensional coordinate translations between cameras so that images of a given object captured by the cameras may be applied to a triangulation algorithm to establish a set of three-dimensional coordinates of that object—which may then be mapped to a three-dimensional reference coordinate system associated with the environment.

In some embodiments, a plurality of optical sensors may be distributed within an environment. The optical sensors may comprise cameras such as, but not limited to, red, blue, and green (RGB) camera sensors, infrared (IR) camera sensors, RGB-IR sensors, monochrome sensors, other types of image sensors that capture image frames, and/or combinations thereof. Individual sensors may be installed at positions with known coordinates (e.g., x, y, and z coordinates) with respect to a known reference frame, with unknown, or only partially known, orientation angles (e.g., role and/or pitch). The environment being monitored by the set of image sensors may comprise any type of facility, such as but not limited to a warehouse, factory, office building, gymnasium, stadium, theater, retail space, or other volume within which 3D tracking of object location using image frames is desired.

In some embodiments, calibration image data is obtained by capturing images (e.g., streaming image data) of a mobile calibration platform, as the mobile calibration platform travels through the environment. The mobile calibration platform may comprise a cart, robot, vehicle, aerial drone, and/or other platform that can be controlled to travel a path through the environment. Concurrently, the mobile platform captures navigation data representing the mobile platform's own location in 3D space. For example, in some embodiments, the mobile calibration platform comprises an inertial navigation sensor that computes a navigation data that includes a set of location data based on inertial data from onboard inertial sensors (e.g., gyroscopes and/or accelerometers).

In some embodiments, the mobile calibration platform may comprise an image sensor that captures images of one or more fiducial markers as the platform travels a path through the monitored environment. For example, fiducial markers may be placed at various locations within the environment at known 3D coordinates and with known orientation angles (e.g., on walls, pillars, supports, or other fixed structural surfaces within the environment). The one or more fiducial markers may comprise, for example, one or more visual fiducial system patterns (e.g., ARtags, AprilTags, QR codes, etc.) that facilitate computing precise 3D position, orientation, and/or identification of the fiducial markers. The fiducial markers may be distributed through the environment at known 3D coordinates, and arranged to be observable by the mobile calibration platform from the path. The number of fiducial markers deployed may vary as a function of the size of the space, but generally may be distributed to span at least a portion the area to be monitored by the plurality of optical sensors. The fiducial markers may have a diversity of alignments and be sufficient in number to produce robust translation and rotation transforms when the optimization is performed. Images of fiducial markers captured by the image sensor of the mobile calibration platform may be timestamped and time-correlated with timestamped image frames of the calibration streaming image data so that correlated data is produced dipicting contextual images of the mobile calibration platform with images of the fiducial marker(s) contemporaneously captured by the onboard image sensor. In some embodiments, the mobile calibration platform may itself be tagged with at least one fiducial marker whose image may be captured by the plurality of optical sensors in the calibration streaming image data. As such, the location of that particular fiducial marker may be determined during optimization based at least on computing a position of the mobile calibration platform appearing in timestamped image frames. Where the mobile calibration platform comprises an aerial drone, one or more of the plurality of optical sensors and/or one or more of the fiducial markers may be installed at elevations at least roughly aligned with the operating elevation of the aerial drone.

In some embodiments, the mobile calibration platform may comprise at least one navigation signal receiver that may compute navigation data that comprises a set of location data based at least on navigation signals transmitted into one or more regions of the monitored environment. A set of navigation transmitters (e.g., beacons) may be positioned along at least a portion of the path traversed by the mobile calibration platform. For example, at least a portion of the monitored environment may comprise an area within which precision navigation (e.g., localization) services are established using an indoor positioning system (IPS). Such an area may represent a region of the environment where robots and/or other machinery operate that need precision real-time location data regarding their position and/or the position of other objects in the environment - more so than is needed for the other regions of the monitored environment. Example indoor positioning systems that may provide navigation signals to the monitored environment include, but are not limited to, technologies based on Institute of Electrical and Electronics Engineers (IEEE) 802.11 (Wi-Fi), Bluetooth, ultra-wide band (UWB), ultrasonic communication signals, millimeter wave (mmWave)-based localization, acoustic signals, radio frequency identification (RFID), and/or other technologies that may be used to transmit wireless navigation signals from known coordinates. In some embodiments, IPS navigation transmitters transmit wireless navigation signals that may be received and processed by the navigation signal receiver of the mobile calibration platform and used to compute a location of the mobile calibration platform in three dimensions (e.g., based on time-of-flight (ToF) and/or triangulation computations). Position data computed by the mobile calibration platform based on the IPS navigation signals may be timestamped and time-correlated with timestamped image frames of the calibration streaming image data so that correlated data is produced that depicts contextual images of the mobile calibration platform with contemporaneously captured IPS-derived location data from the mobile calibration platform.

In operation, as the mobile calibration platform is traveling along the path through the monitored environment, the plurality of optical sensors distributed through the environment are recording timestamped images (e.g., streaming image data) of the mobile calibration platform from various locations and angles. In some embodiments, at least some frames of the streaming image data record images of a fiducial marker on the mobile calibration platform. The streaming image data may be augmented with navigation aid location data and applied to an optimization algorithm, such as a bundle adjustment algorithm, to compute an extrinsic calibration transformation for each of the individual sensors of a plurality of optical sensors distributed through the environment.

In some embodiments, at least a portion of the navigation aid location data is based on timestamped image frames recorded by an onboard camera that captures the one or more fiducial markers positioned within the environment. That is, not every timestamped image frame recorded by the onboard camera is expected to capture one of the fiducial markers. However, recorded image frames that do capture a fiducial marker may be used as a relatively inexpensive resource to estimate a position and orientation of the mobile calibration platform relative to the known position and orientation of the fiducial marker and the time indicated by the timestamp. Similarly, at least a portion of the navigation aid location data may be based on timestamped location data computed using navigation signals transmitted into at least a portion of the monitored environment. The navigation signals may only be available to the mobile calibration platform along one or more limited segments of the path, but for those segments where they are available, the mobile calibration platform can record high-precision 3D location data for its position at the time indicated by the timestamp. Moreover, in some embodiments, the mobile calibration platform may include an inertial navigation system that may compute and record timestamped estimates of the mobile calibration platform's current position (e.g., based on dead-reckoning techniques) as the mobile calibration platform travels the path. Such inertial-based location data may not be as accurate as navigation aid location data derived from fiducial markers or IPS signals, but may be computed purely using onboard resources and therefore available for portions of the path where external navigation aids (e.g., fiducial markers, IPS signals, etc.) are not available.

In some embodiments, the image data from the plurality of optical sensors and the time-correlated navigation aid location data may be used as input to an optimization algorithm (e.g., a bundle adjustment algorithm) to perform an extrinsic camera calibration of the plurality of optical sensors that computes an extrinsic calibration transformation for one or more (e.g., some, all, each, etc.) of the individual sensors of the plurality of optical sensors. The optimization thus represents a fusion of the various forms of navigation aid location data where a limited availability of high-quality location data for the mobile calibration platform may still contribute to the computation of accurate extrinsic calibration transformations for optical sensors not located in the areas where the IPS is operating and/or where fiducial markers are observable. These embodiments thus achieve a fusion by joint optimization that leads to a multi-camera calibration result that is both accurate and relatively inexpensive to implement. A bundle adjustment algorithm may perform a simultaneous refining of 3D coordinates describing the scene geometry with respect to the changing position of the mobile calibration platform, and the optical characteristics (e.g., extrinsic calibration parameters) of the plurality of optical sensors used to acquire the streaming image data. For frames of the streaming image data where contemporaneous navigation location data is available, the optimization may be constrained based on weighing a contribution of a mobile calibration platform location estimate derived from the navigation location data. The bundle adjustment-based optimization outputs, among other computed parameters, an extrinsic calibration transformation for one or more (e.g., each) of the individual sensors of the plurality of optical sensors used to capture the streaming image data. With an extrinsic calibration transformation applied to the output of an optical sensor, the location of a feature (e.g., person, object, etc.) observable from the frame of view of one optical sensor can be mapped to the location on an image frame captured by other optical sensors that also are able to observe the feature, and moreover, the 3D position of the feature may be computed (and/or tracked over time) based on triangulation into the coordinate frame of a 3D reconstructed space established by the bundle adjustment algorithm. In some embodiments, the bundle adjustment algorithm may be implemented at least in part using SLAM algorithms and/or using a Structure-from-Motion (SfM) and/or Multi-View Stereo (MVS) pipeline such as, but not limited to, COLMAP. In some embodiments, the bundle adjustment algorithm may be implemented at least in part using a neural network and/or machine learning model-based technology such as, but not limited to, Neural Radiance Fields (NeRFs) and/or multi-dimensional Gaussian splatting optimization-based techniques. In some embodiments, in some regions of a monitored environment (e.g., a region covered by IPS services), one or more of the plurality of optical sensors may already have established extrinsic calibration parameters determined using another process. In such embodiments, the established extrinsic calibration parameters for those cameras may be used by the optimization algorithm as further constraints on the optimization. In some embodiments, the coordinate frame of the 3D reconstructed space established by the bundle adjustment algorithm comprises a relative coordinate system that may be used to translate coordinates of observable features between fields of view of the optical sensors that have been calibrated together. In some embodiments, the relative coordinate system may be aligned (e.g., using a rigid transformation for rotation and translation) to a global coordinate system associated with the monitored environment (e.g., a factory coordinate space) to determine 3D coordinates for an observed feature in the global coordinate system.

In some embodiments, the optimization algorithm may at least in part be executed using computing resources of a cloud computing platform and/or data center. The computed extrinsic calibration parameters may be used to program one or more downstream computer vision systems that use and/or process the video image feeds from the plurality of optical sensors performing surveillance or other tasks related to the monitored environment. For example, in some embodiments, processing the video image feeds from the calibrated plurality of optical sensors may be used to perform route optimization for automated machines, and/or to track humans, robots, parcels, and/or other goods through a factory, retail establishment, or other facility. A robot path planner may use the calibrated image feeds to dynamically route robots in order to transport items more efficiently, for example by identifying and avoiding obstacles, congestion, or hazards along planned routes. Such use cases benefit from the precision extrinsic calibration of the optical sensors monitoring the environment and the resulting ability to thereby estimate accurate 3D coordinates for observed features.

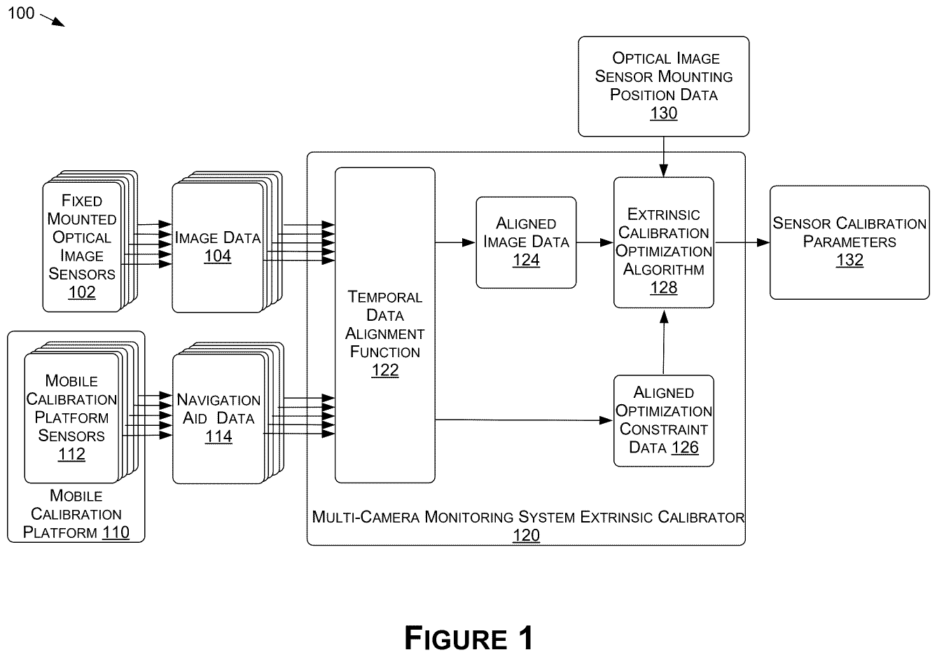

With reference to FIG. 1, FIG. 1 is an example flow diagram for a process for a multi-camera facility extrinsic calibration system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by one or more processors comprising processing circuitry executing instructions stored in memory.

As shown in FIG. 1, the multi-camera facility extrinsic calibration system 100 may comprise a multi-camera monitoring system extrinsic calibrator 120 that generates extrinsic calibration parameters representing relative rotation and translation parameters associated with a network comprising a plurality of fixed mounted optical image sensors 102 to establish a common reference frame for accurate and consistent measurements for locating and tracking objects across the different views captured by the fixed mounted optical image sensors 102.

In some embodiments, the plurality of fixed mounted optical image sensors 102 may be distributed within an environment, which may also be referred to herein as a facility. The fixed mounted optical image sensors 102 may comprise cameras or other image sensors such as, but not limited to, red, blue, and green (RGB) camera sensors, infrared (IR) camera sensors, RGB-IR sensors, monochrome sensors, and/or other types of image sensors (e.g., that capture a field of view as one or more image frames), and/or combinations thereof. Individual sensors are referred to as “fixed mounted” as they are installed at positions with known coordinates (e.g., x, y, and z coordinates) with respect to a known reference frame—but may be installed with unknown, or only partially known, orientation angles (e.g., role and/or pitch). The environment being monitored by the set of image sensors may comprise any type of facility, such as but not limited to a warehouse, factory, office building, gymnasium, stadium, theater, retail space, or other volume within which 3D tracking of object location using image frames is desired. The multi-camera monitoring system extrinsic calibrator 120 may receive video feeds from the plurality of fixed mounted optical image sensors 102 as image data 104. Image data 104 may represent images of at least one mobile platform using a plurality of optical sensors 102 as the at least one mobile platform travels a path through a monitored environment. As discussed herein, the image data 104 may be timestamped so that images of the environment from the field of view are different from individual image sensors 102—or more particularly images that capture the positions of a mobile calibration platform 110 as it travels through the environment—may be aligned (e.g., correlated) in time.

The multi-camera monitoring system extrinsic calibrator 120 may also input navigation aid data 114. As discussed, navigation aid data 114 may comprise location data produced by one or more onboard mobile calibration platform sensors 112 and represent the position of the mobile calibration platform 110 at distinct instances of time as the mobile calibration platform 110 travels through the environment. Like the image data 104, the navigation aid data 114 may be timestamped so that location data generated by different mobile calibration platform sensors 112 may be aligned (e.g., correlated) in time.

As shown in FIG. 1, the multi-camera monitoring system extrinsic calibrator 120 may comprise a temporal data alignment function 122 that receives the image data 104 and navigation aid data 114 and aligns the data in time (e.g., based on timestamps). That is, navigation aid data 114 representing a position of the mobile calibration platform 110 obtained from the onboard mobile calibration platform sensors 112 may be timestamped and time-correlated with timestamped image data 104 so that an aligned set of data comprising aligned image data 124 and aligned optimization constraint data 126 is produced that depicts contextual images of the mobile calibration platform 110 with contemporaneously captured location data received from the mobile calibration platform 110.

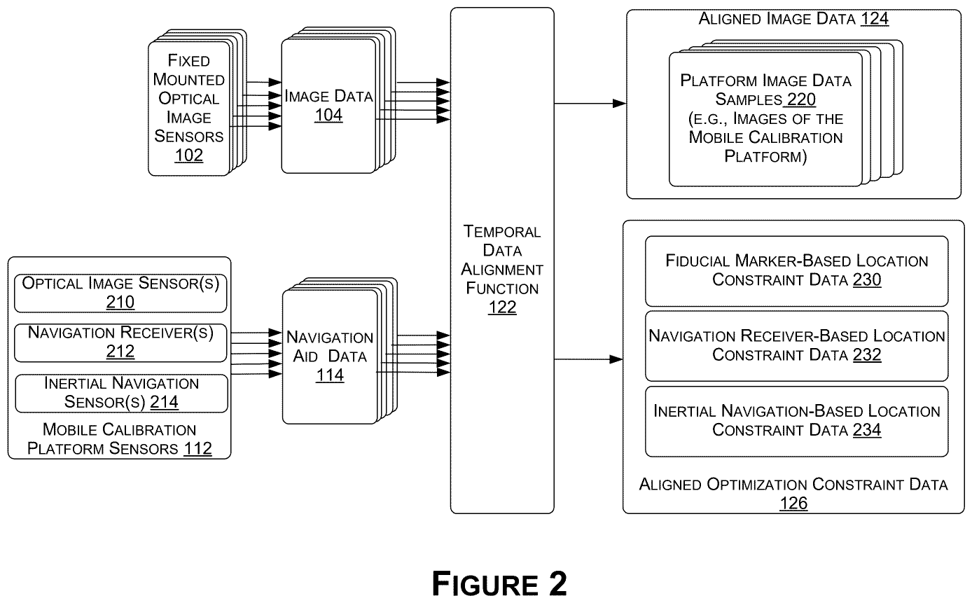

For example, FIG. 2 is a data flow diagram of an example process for producing aligned image data 124 and aligned optimization constraint data 126 produced from the temporal data alignment function 122. In this example, the onboard mobile calibration platform sensors 112 may comprise one or more of optical image sensor(s) 210, navigation receiver(s) 212, inertial navigation sensor(s) 214, and/or other sensors that may produce data indicative of the location of the mobile calibration platform 110.

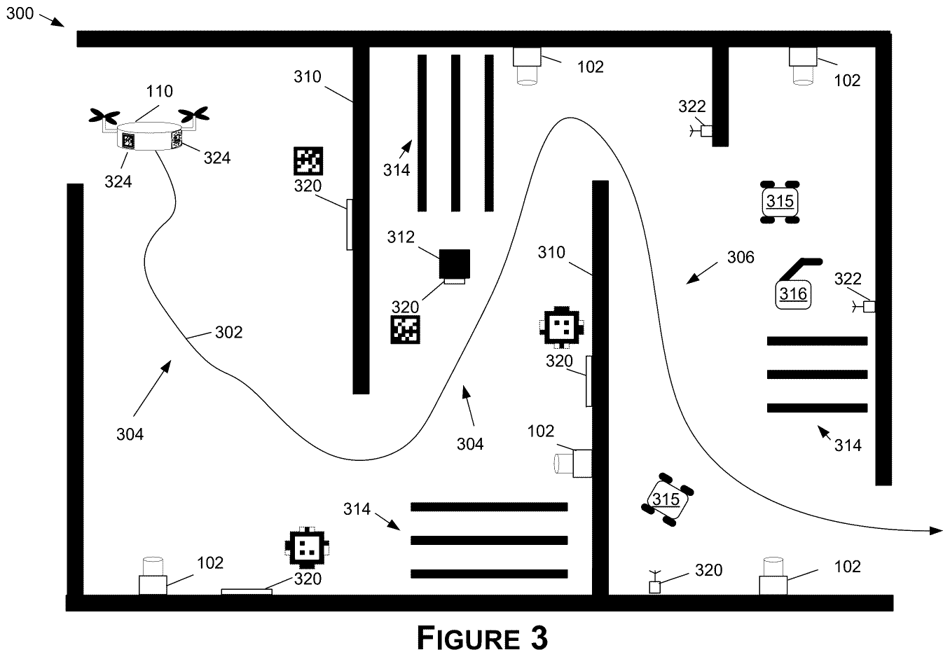

In some embodiments, fixed mounted optical image sensors 102 produce image data 104 from a field of view as seen from the sensors 102 as the mobile calibration platform 110 travels a path through the monitored environment. For example, referring to FIG. 3, FIG. 3 illustrates an example environment 300 through which the mobile calibration platform 110 travels along a path 302 through the environment. The plurality of fixed mounted optical image sensors 102 may be placed at various structure locations such as walls 310, pillars or supports 312 (and/or other fixed structural surfaces within the environment 300) and have a view of the path 302 traveled by the mobile calibration platform 110 from different perspective points. As shown in FIG. 2, image data 104 comprising images of the mobile calibration platform 110 may be timestamped and time-correlated by the temporal data alignment function 122 to generate aligned image data 124 that includes platform image data samples 220 that capture the mobile calibration platform 110 at different times and/or locations as the mobile calibration platform 110 travels path 302. In some embodiments, the mobile calibration platform 110 may itself be tagged with one or more fiducial markers 324, which may be captured by the optical sensors 102 and represented in the platform image data samples 220 that capture the mobile calibration platform 110. In such embodiments, the images of the one or more fiducial markers 324 as captured in a platform image data sample 220 may be processed by the multi-camera monitoring system extrinsic calibrator 120 to determine an attitude angle (e.g., roll, pitch, etc.) of the mobile calibration platform 110 at the instance in time represented by the platform image data sample 220. As such, the location of that particular fiducial marker may be determined during optimization based at least on computing a position of the mobile calibration platform appearing in timestamped image frames.

In some embodiments, optical image sensor(s) 210 of the mobile calibration platform sensors 112 produce image data from a field of view as seen from the mobile calibration platform 110 as it travels the path through the monitored environment. For example, referring to FIG. 3, FIG. 3 illustrates an example environment 300 through which the mobile calibration platform 110 travels along a path 302 through the environment. Within environment 300, fiducial markers 320 may be placed at various structure locations such as walls 310 and pillars or supports 312 (and/or other fixed structural surfaces within the environment 300). The fiducial markers 320 may be positioned within environment 300 at known 3D coordinates and with known orientation angles. The one or more fiducial markers 320 may comprise, for example, one or more visual fiducial system patterns (e.g., ARtags, AprilTags, QR codes, etc.) that facilitate computing precise 3D position, orientation, and/or identification of the fiducial markers. In some embodiments, a set of fiducial markers 320 may be distributed through the environment 300 at locations that are observable by the optical image sensor(s) 210. The quantity of fiducial markers 320 deployed in the environment 300 may vary as a function of the size of the space, but generally may be distributed to span at least a portion of the path 302. For example, in FIG. 3, the fiducial markers 320 are deployed at least along a first portion 304 of the path 302. The fiducial markers 320 may have a diversity of alignments and may be sufficient in number to produce robust translation and rotation transforms when an optimization, as further described herein, is performed by the multi-camera monitoring system extrinsic calibrator 120. As shown in FIG. 2, navigation aid data 114 comprising images of fiducial markers 320 captured by the optical image sensor(s) 210 may be timestamped and time-correlated by the temporal data alignment function 122 with aligned image data 124 to generate fiducial marker-based location constraint data 230. Where the mobile calibration platform 110 comprises an aerial drone, one or more of the fiducial markers 320 may be installed at elevations at least roughly aligned with the operating elevation of the aerial drone.

In some embodiments, at least one navigation receiver 212 may compute location data based on navigation system signals as received at mobile calibration platform 110. For example, referring to FIG. 3, navigation system transmitters 322 may be placed at various structure locations such as walls 310, pillars, or supports 312 (and/or other fixed structural surfaces) and transmit wireless navigation signals within the environment 300 that may be received by navigation receiver(s) 212 as the mobile calibration platform 110 travels the path 302 through the monitored environment 300. As such, the mobile calibration platform 110 may compute an accurate indication of its own location as it traverses through the environment 300.

For example, the portion 306 of path 302 may represent a portion of the monitored environment 300 within which precision navigation (e.g., localization) services are established using an indoor positioning system (IPS) comprising navigation system transmitters 322. Such an area may represent a region of the environment where robots (shown at 315) and/or where other moving machinery (shown at 316) operate that need precision real-time location data regarding their position and/or the position of other objects in the environment - more so than is needed for the other regions of the monitored environment 300.

In some embodiments, navigation system transmitters 322 and/or navigation receiver(s) 212 may operate using one or more wireless localization systems based on technologies such as, but not limited to, IEEE 802.11 (Wi-Fi), Bluetooth, ultra-wide band (UWB), ultrasonic communication signals, millimeter wave (mmWave)-based localization, acoustic signals, RFID, and/or other technologies that may be used to transmit wireless navigation signals from transmitters at known coordinates. In some embodiments, navigation system transmitters 322 transmit wireless navigation signals that may be received and processed by the navigation receiver(s) 212 of the mobile calibration platform 110 and used to compute a location of the mobile calibration platform 110 in three dimensions, for example, based on time-of-flight (ToF) and/or triangulation computations. As shown in FIG. 2, navigation aid data 114 comprising location data computed by the navigation receiver(s) 212 may be timestamped and time-correlated by the temporal data alignment function 122 (e.g., with aligned image data 124) to generate navigation receiver-based location constraint data 232.

In some embodiments, the mobile calibration platform sensors 112 may include one or more inertial navigation sensors 214. In some embodiments, the one or more inertial navigation sensors 214 may comprise one or more microelectromechanical systems (MEMS) accelerometers and/or gyroscope sensors. Based on inertial data from the inertial navigation sensor(s) 214, the mobile calibration platform 110 may compute a current position of the mobile calibration platform 110 (e.g., based on dead-reckoning techniques) as the mobile calibration platform 110 travels the path 302. Such inertial-based navigation aid data 114 may lack in accuracy as compared to location data derived from fiducial markers or navigation signals, but may be computed purely using onboard resources and therefore derivable for portions of the path 302 where other external navigation aids (e.g., fiducial markers, IPS signals, etc.) are not available for computing the mobile calibration platform 110 position. As shown in FIG. 2, navigation aid data 114 comprising location data computed inertial navigation sensor(s) 214 may be timestamped and time-correlated by the temporal data alignment function 122 (e.g., with aligned image data 124) to generate inertial navigation-based location constraint data 234.

As shown in FIG. 1, in some embodiments, the aligned image data 124 may be used as input to an extrinsic calibration optimization algorithm 128 to compute relative translation and rotation parameters associated with the individual fixed mounted optical image sensors 102, with the aligned optimization constraint data 126 input to the extrinsic calibration optimization algorithm 128 to impose constraints on the optimization. In some embodiments, the extrinsic calibration optimization algorithm 128 may further input and/or be programmed with one or more known mounting coordinates (e.g., x, y, and z coordinates) of one or more of the image sensors 102 (shown as optical image sensor mounting position data 130).

In some embodiments, the extrinsic calibration optimization algorithm 128 may comprise, for example, an optimization implemented using a bundle adjustment-based algorithm. The extrinsic calibration optimization algorithm 128 may process the aligned image data 124 and apply the aligned optimization constraint data 126 to perform an extrinsic camera calibration of the plurality of fixed mounted optical image sensors 102 that compute an extrinsic calibration transformation for the individual sensors of the plurality of optical sensors. The resulting extrinsic calibration transformations for individual sensors may be output from the multi-camera monitoring system extrinsic calibrator 120 and used, for example, by an environment monitoring system to determine a position of features (e.g., objects) extracted from image data captured by the plurality of fixed mounted optical image sensors 102 and track those features as they move through the environment 300.

As discussed above, the individual localization technologies that contribute to navigation aid data 114 may vary in the accuracy of the location data they provide, and may also vary with respect to their respective cost and/or complexity to implement. For example, inertial-based location data derived using inertial navigation sensor(s) 214 may be obtained using inexpensive MEMS sensors on the mobile calibration platform 110, and no physical modifications and/or investments to environment 300. Relatively more accurate fiducial marker-based location data may be obtained using slightly more expensive (but still relatively inexpensive) optical image sensor(s) on the mobile calibration platform 110, and modifications to the environment 300 to install passive fiducial markers 320 at known coordinates and orientations. Substantially more accurate navigation signal-based location data may be obtained by employing a wireless localization technology that comprises the deployment of active navigation signal transmitters at known coordinates within the environment 300 and corresponding navigation receivers on the mobile calibration platform 110.

With the optimization performed by the extrinsic calibration optimization algorithm 128, a fusion of diverse forms of navigation aid data 114 is leveraged such that a limited availability of high-quality location constraint data (e.g., navigation receiver-based location constraint data 232, which may be available along portion 306 of the path 302, but not available along portion 304) may still contribute to the computation of accurate extrinsic calibration transformations for those image sensors of the plurality of fixed mounted optical image sensors 102 not located in the areas with high-quality location constraint data and/or where fiducial markers are observable. In some embodiments, the first portion 304 of the path 302 and the second portion 306 of the path 302 may each comprise less than the full length of the path 302 and may represent overlapping or non-overlapping segments of path 302.

In some embodiments, the extrinsic calibration optimization algorithm 128 comprises and/or implements a bundle adjustment algorithm that performs a simultaneous refining of 3D coordinates describing the scene geometry of the environment with respect to the changing position of the mobile calibration platform 110 as it traverses the path 302 and the optical characteristics (e.g., extrinsic calibration parameters) of the plurality of fixed mounted optical image sensors 102 used to acquire the image data 104.

In operation, as the mobile calibration platform 110 is traveling along the path 302 through the monitored environment 300, the plurality of fixed mounted optical image sensors 102 distributed through the environment 300 may be recording timestamped images (e.g., as streaming image data) of the mobile calibration platform 110 from various locations and angles. For frames of the image data 104 where contemporaneous navigation aid data 114 is available, the optimization may be constrained (e.g., using the aligned optimization constraint data 126) based on weighing a contribution of a mobile calibration platform 110 location estimate derived from the navigation aid data 114 and/or aligned optimization constraint data 126. In some embodiments, in some regions of a monitored environment 300, one or more of the plurality of optical sensors 102 may already have established extrinsic calibration parameters determined using another process. In such embodiments, the established extrinsic calibration parameters for those sensors may be used by the extrinsic calibration optimization algorithm 128 as further constraints on the optimization computation.

In some embodiments, a bundle adjustment algorithm may be implemented by the extrinsic calibration optimization algorithm 128 at least in part using SLAM algorithms and/or using a Structure-from-Motion (SfM) and/or Multi-View Stereo (MVS) pipeline such as, but not limited to, COLMAP. In some embodiments, the bundle adjustment algorithm may be implemented by the extrinsic calibration optimization algorithm 128 at least in part using a neural network and/or machine learning model-based technology such as, but not limited to, Neural Radiance Fields (NeRFs) and/or multi-dimensional Gaussian splatting optimization-based techniques. Using bundle adjustment-based optimization, the extrinsic calibration optimization algorithm 128 may compute and output, among other computed parameters, an extrinsic calibration transformation for each of the individual sensors of the plurality of fixed mounted optical image sensors 102 used to capture the image data 104. A resulting set of extrinsic calibration transformations for the fixed mounted optical image sensors 102 is output from the multi-camera monitoring system extrinsic calibrator 120 as sensor calibration parameters 132.

In some embodiments, the coordinate reference frame of a 3D reconstructed space established by the extrinsic calibration transformations produced by the extrinsic calibration optimization algorithm 128 comprises a relative coordinate system that may be used to translate coordinates of observable features between fields of view of the optical sensors 102 that have been calibrated together using the sensor calibration parameters 132. In some embodiments, the relative coordinate system may be aligned (e.g., using a rigid transformation for rotation and translation) to a global coordinate system associated with the monitored environment 300 (e.g., a factory coordinate space) to determine 3D coordinates for an observed feature in the global coordinate system.

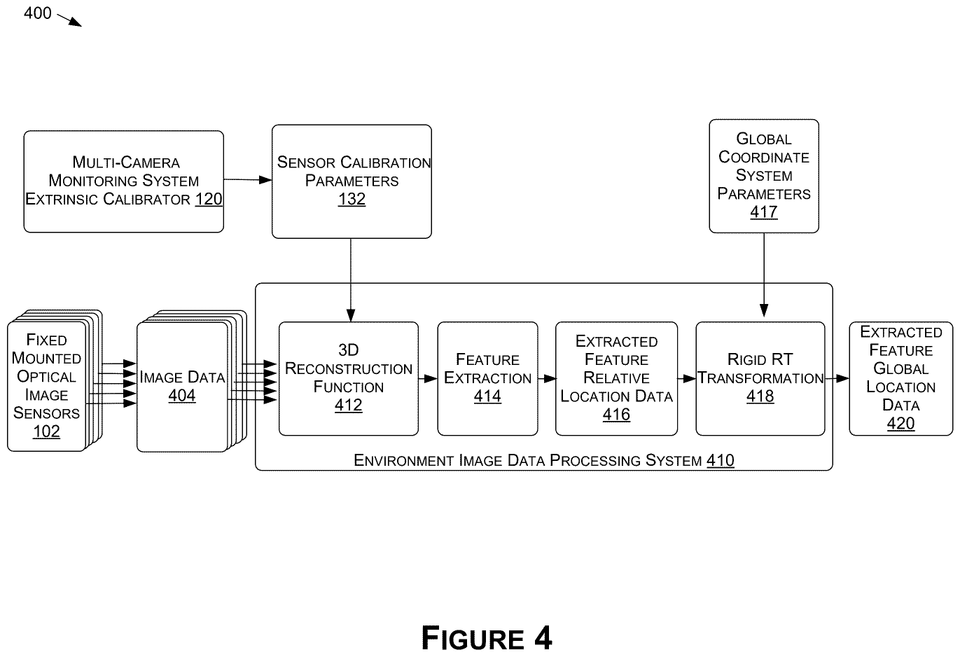

For example, referring now to FIG. 4, FIG. 4 is a data flow diagram illustrating an example environment monitoring system 400, in accordance with some embodiments of the present disclosure. In this example, an environment image data processing system 410 may receive image data 404 comprising a plurality of image data streams (e.g., streaming video data) from the plurality of fixed mounted optical image sensors 102. As discussed herein, the fixed mounted optical image sensors 102 may be distributed throughout a monitored environment (e.g., monitored environment 300), and have been extrinsically calibrated together based on sensor calibration parameters 132 generated by a multi-camera monitoring system extrinsic calibrator 120, as discussed herein.

The sensor calibration parameters 132 permit two-dimensional coordinate translations between images captured by different fixed mounted optical image sensors 102. With an extrinsic calibration transformation (using sensor calibration parameters 132) applied to the output of an optical sensor, the location of a feature (e.g., person, object, etc.) observable from the frame of view of one optical sensor can be mapped to the location on an image frame captured by other optical sensors that also are able to observe the feature, and moreover, the 3D position of the feature may be computed (and/or tracked over time) based on triangulation into the coordinate frame of a 3D reconstructed space established by the bundle adjustment algorithm. That is, when an object is detected and/or extracted from a location (e.g., coordinates) within a first image frame produced by a first optical image sensor 102, rotation-translation transformations may be applied that map (e.g., project) the object to the corresponding location (e.g., coordinates) within a second image frame produced by a second optical image sensor 102. As such, in some embodiments, environment image data processing system 410 comprises a 3D reconstruction function 412 that for individual feeds of image data 404, applies a corresponding set of calibration parameters from sensor calibration parameters 132. The calibration parameters applied to an individual feed comprise a rotation-translation (RT) transformation computed by the extrinsic calibration optimization algorithm 128 for the particular optical image sensor 102—and provide an indication of the relative attitude angle (rotation and translation) of images captured by that optical image sensor 102 with respect to the other optical image sensors 102 and/or a global frame of reference of the monitored environment. That is, by applying the transforms of the sensor calibration parameters 132 to the image feeds of image data 404, the 3D reconstruction function 412 may produce a 3D frame of reference comprising a relative coordinate system that facilitates mapping of local image coordinates between image frames of image sensors and outputs a calibrated version of the image data 404 where image frames are translated to the 3D frame of reference. In some embodiments, the environment image data processing system 410 processes the calibrated image data to perform a feature extraction 414. The feature extraction 414 may comprise a feature detection machine learning model that identifies features (e.g., objects) of interest from the calibrated image data and extracts a location of those features to produce extracted feature relative location data 416. In some embodiments, the environment image data processing system 410 may apply a rigid RT transformation 418 (e.g., determined from one or more global coordinate system parameters 417, such as a transformation, for the monitored environment) to map extracted feature relative location data 416 to a global three-dimensional coordinate system for the monitored environment and produce extracted feature global location data 420. As such, a feature represented in image data 404 as captured by one or more of the optical image sensors 102 may be identified and its position thus established and/or tracked in the global 3D coordinate system of the monitored environment.

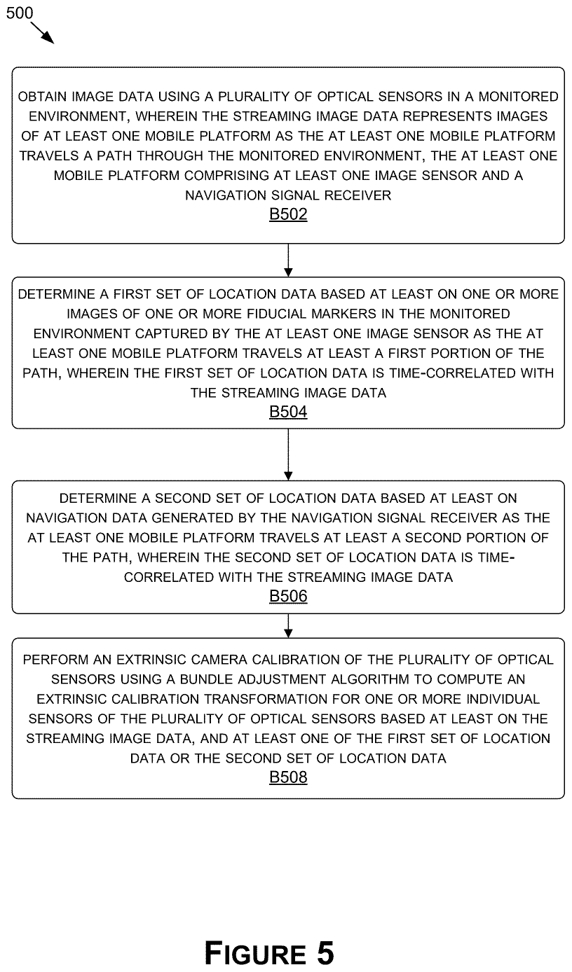

Now referring to FIG. 5, FIG. 5 is a flow diagram showing a method 500 for multi-camera facility extrinsic calibration in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by one or more processors (e.g., one or more processing units comprising processing circuitry) executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to the multi-camera facility extrinsic calibration system 100 and/or the multi-camera monitoring system extrinsic calibrator 120 of FIG. 1. However, these methods may additionally or alternatively be executed by any one system, or any combination of systems, including, but not limited to, those described herein.

As discussed herein in greater detail, the method may in general include calibrating a plurality of optical sensors using an optimization algorithm to compute an extrinsic calibration transformation for one or more individual sensors of the plurality of optical sensors, the extrinsic calibration transformation computed using a bundle adjustment algorithm and based at least on image data representing at least one mobile platform as the at least one mobile platform travels a path through a monitored environment, and based at least on navigation data captured from the monitored environment by at least one sensor of the at least one mobile platform as the at least one mobile platform travels the path through the monitored environment, wherein the navigation data is time-correlated with the image data.

The method 500, at block B502, includes obtaining image data using a plurality of optical sensors in a monitored environment, wherein the streaming image data represents images of at least one mobile platform as the at least one mobile platform travels a path through the monitored environment, the at least one mobile platform comprising at least one image sensor and a navigation signal receiver. The at least one mobile platform may comprise, for example, at least one of a cart, a robot, a vehicle, or an aerial drone.

As discussed with respect to FIG. 1, a plurality of fixed mounted optical image sensors 102 may be distributed within an environment, which may also be referred to herein as a facility. The fixed mounted optical image sensors 102 may comprise cameras or other image sensors such as, but not limited to, red, blue, and green (RGB) camera sensors, infrared (IR) camera sensors, RGB-IR sensors, monochrome sensors, and/or other types of image sensors (e.g., that capture a field of view as one or more image frames), and/or combinations thereof. The environment being monitored by the set of image sensors may comprise any type of facility, such as but not limited to a warehouse, factory, office building, gymnasium, stadium, theater, retail space, or other volume within which 3D tracking of object location using image frames is desired. In some embodiments, fixed mounted optical image sensors 102 produce image data 104 from a field of view as seen from the sensors 102 as the mobile calibration platform 110 travels a path through the monitored environment. For example, referring to FIG. 3, FIG. 3 illustrates an example environment 300 through which the mobile calibration platform 110 travels along a path 302 through the environment. In some embodiments, one or more fixed objects 314 may be located within the environment 300 (e.g., warehouse shelves, plant machinery, desks, etc.). The plurality of fixed mounted optical image sensors 102 may be placed at various structure locations such as walls 310 and pillars or supports 312 (and/or other fixed structural surfaces within the environment 300) and have a view of the path 302 traveled by the mobile calibration platform 110 from different perspective points. In some embodiments, onboard mobile calibration platform sensors 112 may comprise one or more of optical image sensor(s) 210, navigation receiver(s) 212, inertial navigation sensor(s) 214, and/or other sensors that may produce data indicative of the location of the mobile calibration platform 110. Optical image sensor(s) 210 of the mobile calibration platform sensors 112 produce image data from a field of view as seen from the mobile calibration platform 110 as it travels the path through the monitored environment, and in some embodiments, navigation receiver(s) 212 computes location data based on navigation system signals received at the mobile calibration platform 110.

The method 500, at block B504, includes determining a first set of location data based at least on one or more images of one or more fiducial markers in the monitored environment captured by the at least one image sensor as the at least one mobile platform travels at least a first portion of the path, wherein the first set of location data is time-correlated with the streaming image data. In some embodiments, the at least one mobile platform comprises at least one fiducial marker visible to one or more of the plurality of optical sensors, and wherein the processing circuitry may further compute the extrinsic calibration transformation for individual sensors of the plurality of optical sensors further based at least on the at least one fiducial marker as captured by the image data. As discussed with respect to FIG. 3, within an environment, fiducial markers 320 may be placed at various structure locations such as walls 310, pillars, or supports 312 (and/or other fixed structural surfaces within the environment 300). The fiducial markers 320 may be positioned within environment 300 at known 3D coordinates and with known orientation angles. The one or more fiducial markers 320 may comprise, for example, one or more visual fiducial system patterns (e.g., ARtags, AprilTags, QR codes, etc.) that facilitate computing precise 3D position, orientation, and/or identification of the fiducial markers. In some embodiments, a set of fiducial markers 320 may be distributed through the environment 300 at locations that are observable by the optical image sensor(s) 210. For example, in FIG. 3, the fiducial markers 320 are deployed at least along a first portion 304 of the path 302. The fiducial markers 320 may have a diversity of alignments and be sufficient in number to produce robust translation and rotation transforms when an optimization, as further described herein, is performed by the multi-camera monitoring system extrinsic calibrator 120. As shown in FIG. 2, navigation aid data 114 comprising images of fiducial markers 320 captured by the optical image sensor(s) 210 may be timestamped and time-correlated by the temporal data alignment function 122 with aligned image data 124 to generate fiducial marker-based location constraint data 230.

The method 500, at block B506, includes determining a second set of location data based at least on navigation data generated by the navigation signal receiver as the at least one mobile platform travels at least a second portion of the path, wherein the second set of location data is time-correlated with the streaming image data. In some embodiments, the at least one mobile platform comprises at least one inertial navigation system, and the processing circuitry may further compute the extrinsic calibration transformation for individual sensors of the plurality of optical sensors further based at least on inertial-based location data generated by the at least one inertial navigation system.

In some embodiments, navigation receiver(s) 212 computes location data based on navigation system signals as received at mobile calibration platform 110. For example, referring to FIG. 3, navigation system transmitters 322 may be placed at various structure locations such as walls 310, pillars, or supports 312 (and/or other fixed structural surfaces) and transmit wireless navigation signals within the environment 300 that may be received by navigation receiver(s) 212 as the mobile calibration platform 110 travels the path 302 through the monitored environment 300. As such, the mobile calibration platform 110 may compute an accurate indication of its own location as it traverses through the environment 300. For example, the portion 306 of path 302 may represent a portion of the monitored environment 300 within which precision navigation (e.g., localization) services are established using an indoor positioning system (IPS) comprising navigation system transmitters 322. In some embodiments, navigation system transmitters 322 and/or navigation receiver(s) 212 may operate using one or more wireless localization systems based on technologies such as, but not limited to, IEEE 802.11 (Wi-Fi), Bluetooth, ultra-wide band (UWB), ultrasonic communication signals, millimeter wave (mmWave)-based localization, acoustic signals, RFID, and/or other technologies that may be used to transmit wireless navigation signals from transmitters at known coordinates. In some embodiments, navigation system transmitters 322 transmit wireless navigation signals that may be received and processed by the navigation receiver(s) 212 of the mobile calibration platform 110 and used to compute a location of the mobile calibration platform 110 in three dimensions, for example, based on time-of-flight (ToF) and/or triangulation computations. As shown in FIG. 2, navigation aid data 114 comprising location data computed by the navigation receiver(s) 212 may be timestamped and time-correlated by the temporal data alignment function 122 (e.g., with aligned image data 124) to generate navigation receiver-based location constraint data 232.

The method 500, at block B508, includes performing an extrinsic camera calibration of the plurality of optical sensors using a bundle adjustment algorithm to compute an extrinsic calibration transformation for one or more individual sensors of the plurality of optical sensors based at least on the streaming image data, and at least one of the first set of location data or the second set of location data. The image data, and at least one of the first set of location data and the second set of location data, may be time-correlated based on timestamps.

As shown in FIG. 1, the multi-camera monitoring system extrinsic calibrator 120 may comprise a temporal data alignment function 122 that receives the image data 104 and navigation aid data 114 and aligns the data in time (e.g., based on timestamps). That is, navigation aid data 114 representing a position of the mobile calibration platform 110 obtained from the onboard mobile calibration platform sensors 112 may be timestamped and time-correlated with timestamped image data 104 so that an aligned set data comprising aligned image data 124 and aligned optimization constraint data 126 is produced that depicts contextual images of the mobile calibration platform 110 with contemporaneously captured location data received from the mobile calibration platform 110. For example, FIG. 2 provides an example illustration of aligned image data 124 and aligned optimization constraint data 126 produced from the temporal data alignment function 122. As shown in FIG. 1, in some embodiments, the aligned image data 124 may be used as input to an extrinsic calibration optimization algorithm 128 to compute relative translation and rotation parameters associated with the individual fixed mounted optical image sensors 102, with the aligned optimization constraint data 126 input to the extrinsic calibration optimization algorithm 128 to impose constraints on the optimization. In some embodiments, the extrinsic calibration optimization algorithm 128 may further input and/or be programmed with one or more known mounting coordinates (e.g., x, y, and z coordinates) of one or more of the image sensors 102 (shown as optical image sensor mounting position data 130).

In some embodiments, the extrinsic calibration optimization algorithm 128 may comprise, for example, an optimization implemented using a bundle adjustment-based algorithm. The extrinsic calibration optimization algorithm 128 may process the aligned image data 124 and apply the aligned optimization constraint data 126 to perform an extrinsic camera calibration of the plurality of fixed mounted optical image sensors 102 that compute an extrinsic calibration transformation for the individual sensors of the plurality of optical sensors. The resulting extrinsic calibration transformations for individual sensors may be output from the multi-camera monitoring system extrinsic calibrator 120 and used, for example, by an environment monitoring system to determine a position of features (e.g., objects) extracted from image data captured by the plurality of fixed mounted optical image sensors 102 and track those features as they move through the environment 300. In some embodiments, the extrinsic calibration optimization algorithm 128 comprises and/or implements a bundle adjustment algorithm that performs a simultaneous refining of 3D coordinates describing the scene geometry of the environment with respect to the changing position of the mobile calibration platform 110 as it traverses the path 302, and the optical characteristics (e.g., extrinsic calibration parameters) of the plurality of fixed mounted optical image sensors 102 used to acquire the image data 104. As the mobile calibration platform 110 is traveling along the path 302 through the monitored environment 300, the plurality of fixed mounted optical image sensors 102 distributed through the environment 300 may be recording timestamped images (e.g., as streaming image data) of the mobile calibration platform 110 from various locations and angles. For frames of the image data 104 where contemporaneous navigation aid data 114 is available, the optimization may be constrained (e.g., using the aligned optimization constraint data 126) based on weighing a contribution of a mobile calibration platform 110 location estimate derived from the navigation aid data 114 and/or aligned optimization constraint data 126.

In some embodiments, a bundle adjustment algorithm may be implemented (e.g., by the extrinsic calibration optimization algorithm 128) at least in part using SLAM algorithms and/or using a Structure-from-Motion (SfM) and/or Multi-View Stereo (MVS) pipeline such as, but not limited to, COLMAP. In some embodiments, the bundle adjustment algorithm may be implemented by the extrinsic calibration optimization algorithm 128 at least in part using a neural network and/or machine learning model-based technology such as, but not limited to, Neural Radiance Fields (NeRFs) and/or multi-dimensional Gaussian splatting optimization-based techniques. Using bundle adjustment-based optimization, the extrinsic calibration optimization algorithm 128 may compute and output, among other computed parameters, an extrinsic calibration transformation for each of the individual sensors of the plurality of fixed mounted optical image sensors 102 used to capture the image data 104. A resulting set of extrinsic calibration transformations for the fixed mounted optical image sensors 102 is output from the multi-camera monitoring system extrinsic calibrator 120 as sensor calibration parameters 132.

The sensor calibration parameters 132 permit two-dimensional coordinate translations between images captured by different fixed mounted optical image sensors 102. With an extrinsic calibration transformation (using sensor calibration parameters 132) applied to the output of an optical sensor, the location of a feature (e.g., person, object, etc.) observable from the frame of view of one optical sensor can be mapped to the location on an image frame captured by other optical sensors that also are able to observe the feature, and moreover, the 3D position of the feature may be computed (and/or tracked over time) based on triangulation into the coordinate frame of a 3D reconstructed space established by the bundle adjustment algorithm. When an object is detected and/or extracted from a location (e.g., coordinates) within a first image frame produced by a first optical image sensor 102, rotation-translation transformations may be applied that map (e.g., project) the object to the corresponding location (e.g., coordinates) within a second image frame produced by a second optical image sensor 102.

In some embodiments, an environment image data processing system may determine and/or apply a rigid RT transformation (e.g., determined from global coordinate system parameters for the monitored environment) to map the relative coordinate system associated with the extrinsic camera calibration of the plurality of optical sensors to a global three-dimensional coordinate system for the monitored environment. For example, as illustrated in FIG. 4, extracted feature relative location data 416 may be mapped to a global three-dimensional coordinate system for the monitored environment to produce extracted feature global location data 420. As such, a feature represented in image data 404 as captured by one or more of the optical image sensors 102 may be identified and its position thus established and/or tracked in the global 3D coordinate system of the monitored environment.

In some embodiments, the systems and methods described herein may be performed within, or in conjunction with, a simulation environment (e.g., NVIDIA's DriveSIM) using simulated data (e.g., simulated sensor data of simulated sensors of a virtual or simulated machine). For example, simulated sensor data and/or map data may be used that includes image data captured by a plurality of fixed mounted optical image sensors deployed to monitor an environment within the simulation environment - and those optical image sensors are extrinsically calibrated together based on fixed mounted optical image sensor calibration parameters to produce a 3D reconstruction of the monitored environment. The simulation environment may use this image data and/or fixed mounted optical image sensor calibration parameter information to perform operations (e.g., navigating) associated with the virtual machine within the environment. These simulated operations may be used to test performance of the underlying algorithms, systems, and/or processes prior to deploying them in the real world. In some instances, the simulation may be used to generate synthetic training data—e.g., training data including regions of interest and/or subregions of interest from within the simulation. The synthetic training data (in addition to or alternatively from real-world data) may then be processed to determine geometry and/or other information related to road surfaces, for example. In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing a universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems - such as systems for testing, validating, training (e.g., machine learning models, neural networks, etc.), and/or other tasks related to automotive, robot, machine, or other applications.

In some embodiments, teleoperation or remote control of a vehicle or other machine may be performed using a remote control or teleoperation system. For example, the systems and methods described herein may be used to produce processed image data related to animated or static objects, hazards, etc., which may be used or included in a visualization or mapping of an environment to aid a remote operator in controlling—or providing waypoints or other indications of control or navigation—an autonomous or semi-autonomous machine through an environment.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models), and memory and/or storage (e.g., for storing entertainment content, navigation data, and user preferences). The system may use these processors to execute one or more machine learning models to enable features such as occupant monitoring, gesture recognition, and real-time communication with other services through network connectivity. The in-vehicle infotainment system may also use natural language processing (NLP) models to enable voice-based interaction. The one or more machine learning models may be stored locally or accessed through one or more application programming interfaces (APIs) that connect to cloud services, enabling the system to process requests in real-time or near real-time.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers, etc.) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, vision language models (VLMs), large language models (LLMs), multimodal language models (MMLMs), diffusion models, NeRF models, deep neural networks (DNNs), etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some examples, the machine learning model(s) (e.g., deep neural networks, language models, LLMs, VLMs, multimodal language models, perception models, tracking models, fusion models, transformer models, diffusion models, encoder-only models, decoder-only models, encoder-decoder models, neural rendering field (NeRF) models, etc.) described herein may be packaged (and/or deployed) as one or more cloud-hosted microservices—such as one or more inference microservices (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a preconfigured container for simplified deployment, an optimized inference engine (e.g., built using a standardized AI model deployment and execution software, such as NVIDIA's Triton Inference Server, and/or one or more APIs for high-performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device or up to data-center scale). As such, the inference microservice may include the machine learning model(s) (e.g., that has been optimized for high-performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs) and/or one or more multi-modal language models (MMLMs), systems for performing light transport simulation, systems for performing collaborative content creation for 3D assets, systems implemented at least partially using cloud computing resources, and/or other types of systems.

### EXAMPLE COMPUTING DEVICE

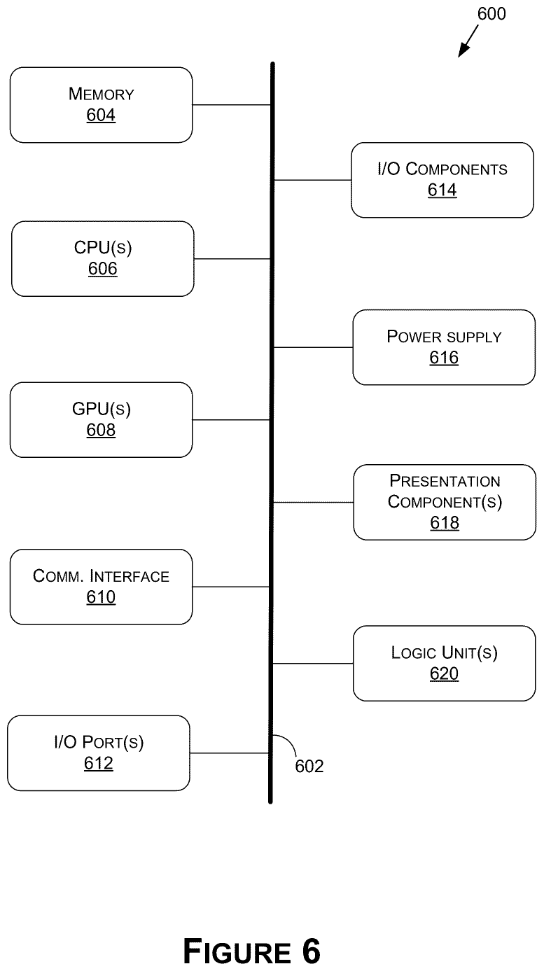

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more functions of the multi-camera facility extrinsic calibration system 100 and/or multi-camera monitoring system extrinsic calibrator 120 may be performed at least in part by computing device(s) 600. In some embodiments, one or more functions of the environment monitoring system 410 may be performed at least in part by computing device(s) 600.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608. In some embodiments, one or more functions of the multi-camera facility extrinsic calibration system 100 and/or multi-camera monitoring system extrinsic calibrator 120 may be performed at least in part by code executed by CPU(s) 606, GPU(s) 608, and/or the logic unit(s) 620. In some embodiments, one or more functions of the environment monitoring system 410 may be performed at least in part by code executed by CPU(s) 606, GPU(s) 608, and/or the logic unit(s) 620.

Examples of the logic unit(s) 620 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that allow the computing device 600 to communicate with other computing devices via an electronic communication network, included wired and/or wireless communications. The communication interface 610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may allow the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that allow detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to allow the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, one or more renderings of a monitored environment (e.g., environment 300) may be generated by computing device 600 and displayed on one or more presentation component(s) 618 based on an extrinsic calibration of fixed mounted optical image sensors 102 obtained using sensor calibration parameters 132 computed as described herein.

### EXAMPLE DATA CENTER

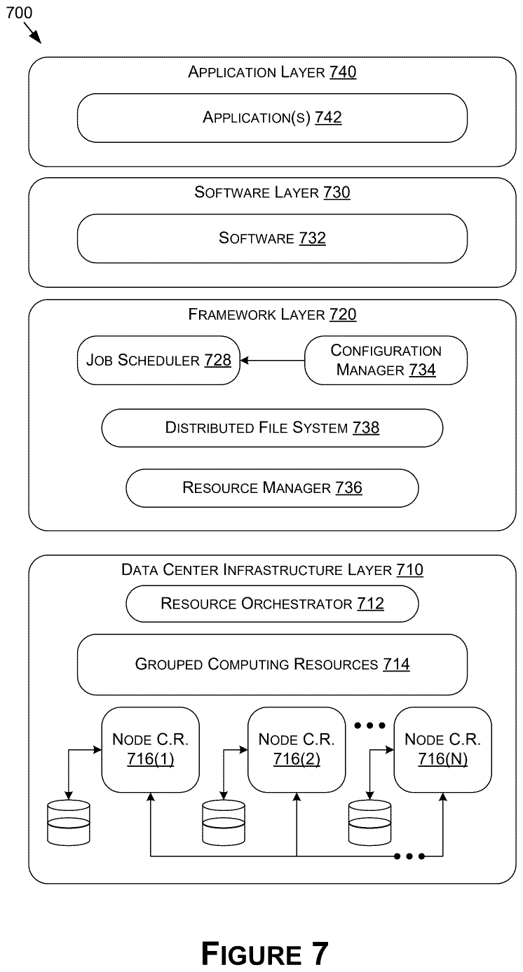

FIG. 7 illustrates an example data center 700 that may be used in at least one embodiments of the present disclosure. The data center 700 may include a data center infrastructure layer 710, a framework layer 720, a software layer 730, and/or an application layer 740.

In some embodiments, one or more functions of the multi-camera facility extrinsic calibration system 100 and/or multi-camera monitoring system extrinsic calibrator 120 may be performed at least in part using data center 700. In some embodiments, one or more functions of the environment monitoring system 410 may be performed at least in part by code executed using data center 700.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof. In some embodiments, one or more functions of the multi-camera facility extrinsic calibration system 100 and/or multi-camera monitoring system extrinsic calibrator 120 may be performed at least in part by code executed by one or more node C.R.s 716(1)-716(N). In some embodiments, one or more functions of the environment monitoring system 410 may be performed at least in part by code executed by one or more node C.R.s 716(1)-716(N).

In at least one embodiment, as shown in FIG. 7, framework layer 720 may include a job scheduler 728, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may use distributed file system 738 for large-scale data processing (e.g., “big data”). In at least one embodiment, job scheduler 728 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 728. In at least one embodiment, clustered or grouped computing resources may include grouped computing resource 714 at data center infrastructure layer 710. The resource manager 736 may coordinate with resource orchestrator 712 to manage these mapped or allocated computing resources. In some embodiments, software 732 and/or application(s) 742 may comprise code that when executed perform one or more functions of the multi-camera facility extrinsic calibration system 100 and/or multi-camera monitoring system extrinsic calibrator 120. In some embodiments, software 732 and/or application(s) 742 may comprise code that when executed perform one or more functions of the environment monitoring system 410.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments - in which case a server may not be included in a network environment - and one or more client-server network environments - in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
obtain image data using a plurality of optical sensors in a monitored environment, wherein the image data represents images of at least one mobile platform as the at least one mobile platform travels a path through the monitored environment, the at least one mobile platform comprising at least one image sensor and a navigation signal receiver;
determine a first set of location data based at least on one or more images of one or more fiducial markers in the monitored environment captured by the at least one image sensor as the at least one mobile platform travels at least a first portion of the path, wherein the first set of location data is time-correlated with the image data;
determine a second set of location data based at least on navigation data generated by the navigation signal receiver as the at least one mobile platform travels at least a second portion of the path, wherein the second set of location data is time-correlated with the image data; and
perform an extrinsic camera calibration of the plurality of optical sensors using a bundle adjustment algorithm to compute an extrinsic calibration transformation for one or more individual sensors of the plurality of optical sensors based at least on the image data, and at least one of the first set of location data or the second set of location data.

2. The one or more processors of claim 1, wherein the processing circuitry is further to:
determine a transform to map a relative coordinate system associated with the extrinsic camera calibration of the plurality of optical sensors to a global three-dimensional coordinate system for the monitored environment.

3. The one or more processors of claim 1, wherein the at least one mobile platform comprises at least one fiducial marker visible to one or more of the plurality of optical sensors; and
wherein the processing circuitry is further to compute the extrinsic calibration transformation for one or more individual sensors of the plurality of optical sensors further based at least on the at least one fiducial marker as captured by the image data.

4. The one or more processors of claim 1, wherein the at least one mobile platform comprises at least one inertial navigation system; and
wherein the processing circuitry is further to compute the extrinsic calibration transformation for one or more individual sensors of the plurality of optical sensors further based at least on inertial-based location data generated by the at least one inertial navigation system.

5. The one or more processors of claim 1, wherein the at least one mobile platform comprises at least one of a cart, a robot, a vehicle, or an aerial drone.

6. The one or more processors of claim 1, wherein the navigation signal receiver computes the second set of location data based at least on receiving one or more of IEEE 802.11 (Wi-Fi) technology signals, Bluetooth technology signals, ultra-wide band (UWB) signals, ultrasonic communication signals, millimeter wave (mmWave)-based localization signals, acoustic signals, or radio frequency identification (RFID) signals.

7. The one or more processors of claim 1, wherein the one or more fiducial markers comprise at least one of an ARtag, an AprilTag, or a QR code.

8. The one or more processors of claim 1, wherein the image data, and at least one of the first set of location data and the second set of location data, are time-correlated based on timestamps.

9. The one or more processors of claim 1, wherein the first portion of the path and the second portion of the path are each less than a full length of the path.

10. The one or more processors of claim 1, wherein the processing circuitry is further to perform the extrinsic camera calibration of the plurality of optical sensors using the bundle adjustment algorithm, wherein the bundle adjustment algorithm is based at least on one of:
a Simultaneous Localization and Mapping (SLAM) algorithm;
a Structure-from-Motion (SfM) optimization technique;
a Multi-View Stereo (MVS) optimization technique;
a Neural Radiance Field (NeRF) optimization technique; or
a multi-dimensional Gaussian splatting optimization technique.

11. The one or more processors of claim 1, wherein the processing circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multimodal language models;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

12. A system comprising one or more processors to:
generate image data representing images of at least one mobile platform using a plurality of optical sensors as the at least one mobile platform travels a path through a monitored environment;
generate navigation data based at least on a signal representative of a position of the at least one mobile platform, wherein the signal is based at least on location information captured from the monitored environment by at least one sensor of the at least one mobile platform; and
calibrate the plurality of optical sensors using an optimization algorithm to compute an extrinsic calibration transformation for one or more individual sensors of the plurality of optical sensors based at least on the images of the at least one mobile platform and the navigation data.

13. The system of claim 12, wherein the at least one sensor comprises at least one image sensor, wherein the one or more processors are further to:
generate the navigation data based on a set of location data comprising one or more images of one or more fiducial markers in the monitored environment captured by the at least one image sensor as the at least one mobile platform travels at least a first portion of the path, wherein the set of location data is time-correlated with the image data.

14. The system of claim 13, wherein the one or more fiducial markers comprise at least one of an ARtag, an AprilTag, or a QR code.

15. The system of claim 12, wherein the at least one sensor comprises at least one navigation signal receiver, wherein the one or more processors are further to:
generate the navigation data based on a set of location data generated by the at least one navigation signal receiver as the at least one mobile platform travels at least a second portion of the path, wherein the set of location data is time-correlated with the image data.

16. The system of claim 15, wherein the at least one navigation signal receiver computes the set of location data based at least on receiving one or more of: IEEE 802.11 (Wi-Fi) technology signals, Bluetooth technology signals, ultra-wide band (UWB) signals, ultrasonic communication signals, millimeter wave (mmWave)-based localization signals, acoustic signals, or radio frequency identification (RFID) signals.

17. The system of claim 12, wherein the one or more processors are further to compute the extrinsic calibration transformation for one or more individual sensors of the plurality of optical sensors, wherein the optimization algorithm comprises a bundle adjustment algorithm.

18. The system of claim 17, wherein the one or more processors are further to compute the extrinsic calibration transformation using the bundle adjustment algorithm based on at least one of:
a Simultaneous Localization and Mapping (SLAM) algorithm;
a Structure-from-Motion (SfM) optimization technique;
a Multi-View Stereo (MVS) optimization technique;
a Neural Radiance Field (NeRF) optimization technique; or
a multi-dimensional Gaussian splatting optimization technique.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multimodal language models;
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
calibrating a plurality of optical sensors using an optimization algorithm to compute an extrinsic calibration transformation for one or more individual sensors of the plurality of optical sensors, the extrinsic calibration transformation computed using a bundle adjustment algorithm and based at least on image data representing at least one mobile platform as the at least one mobile platform travels a path through a monitored environment, and based at least on navigation data captured from the monitored environment by at least one sensor of the at least one mobile platform as the at least one mobile platform travels the path through the monitored environment, wherein the navigation data is time-correlated with the image data.
